(19) United States
(12) Patent Application Publication
(10) Pub. No.: US 2011/0221679 A1
(43) Pub. Date: Sep. 15, 2011

(54) ELECTRONIC BOOK READER

(75) Inventors: CHUN-WEI PAN, Tu-Cheng (TW); KUAN-HONG HSIEH, Tu-Cheng (TW); HAN-CHE WANG, Tu-Cheng (TW)

(73) Assignee: HON HAI PRECISION INDUSTRY CO., LTD., Tu-Cheng (TW)

(21) Appl. No.: 12/885,568

(22) Filed: Sep. 19, 2010

(30) Foreign Application Priority Data
Mar. 12, 2010 (CN) 201010123247.4

(51) Int. Cl. G06F 3/02

(52) U.S. Cl. 345/168

(57) ABSTRACT

An electronic book reader includes an E-paper display, a display controller, a SDRAM, and a group of control buttons. The display controller is connected to the E-paper display. The SDRAM is connected to the display controller, and stores a group of display data. The control buttons are electrically connected to the display controller for responding to user input and generating an updating signal to the display controller to open a destination page. The display controller is configured for accessing the SDRAM to obtain the display data of the destination page upon receiving the updating signal, and driving the E-paper display to display the destination page.

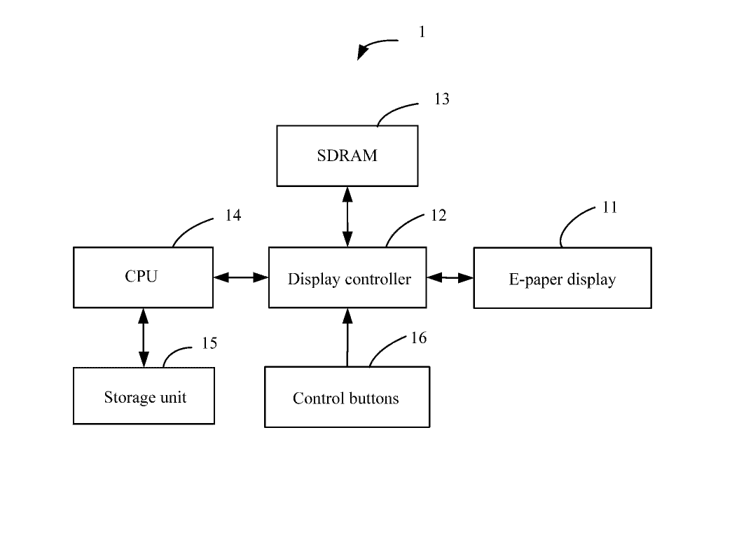

### BACKGROUND

1. Technical Field

The present disclosure relates to electronic book readers and, particularly, to an electronic book reader with an electronic paper display.

2. Description of Related Art

Commonly, to turn a page on the display of an electronic book reader, a button is pushed to send a signal to a CPU, and then the CPU converts the signal into a updating command and outputs the command to a display controller to drive the E-paper display to open a destination page. Therefore, each time the user turns a page on the display, the CPU needs to be involved, which can consume a lot of power.

### BRIEF DESCRIPTION OF THE DRAWINGS

The components of the drawings are not necessarily drawn to scale, the emphasis instead being placed upon clearly illustrating the principles of an electronic book reader. Moreover, in the drawings, like reference numerals designate corresponding parts throughout several views.

The drawing is a block diagram showing an electronic book in accordance with an exemplary embodiment.

### DETAILED DESCRIPTION

Referring to the drawing, an electronic book reader (E-book reader) 1 includes an E-paper display 11, a display controller 12, a number of control buttons 16, a synchronous dynamic random access memory (SDRAM) 13, a central processing unit (CPU) 14, and a storage unit 15.

The electronic-paper (E-paper) display 11 is bi-stable, which means that the display 11 needs power only to update the content on the display 11. The E-paper display 11 is for presenting graphic content or textual content.

The display controller 12 is connected to the E-paper display 11 and is configured to drive the E-paper display 11. The display controller 12 is also connected to the CPU 14 through a bus interface.

The SDRAM 13 is connected to the display controller 12 by buses. The SDRAM stores display data of a group of sequential pages.

The CPU 14 is also connected to the storage unit 15 which stores display data of many groups of pages. The CPU 14 can copy the display data from the storage unit 15 into the SDRAM 13 via the display controller 12.

The control buttons 16 are electrically connected to the display controller 12 for responding to user input and generating an updating signal to the display controller 12 to open a destination page.

When the user operates the control buttons 16 to open a destination page, the updating signal is directly output to the display controller 12 rather than to the CPU 14. The display controller 12 receives the updating signal and accesses the display data of the destination page in the SDRAM 13, and then the display controller 12 reads the display data and drives the E-paper display 11 to display the destination page. In the above process, the CPU 14 is asleep if no other task needs to be dealt with.

If the display controller 12 determines the display data of the destination page is not in the SDRAM 13, the display controller 12 outputs a staring signal to wake up the CPU 14, the CPU 14 then copies display data of a group of new pages containing the destination page from the storage unit 15 into the SDRAM 13 via the display controller 12. After completing the task the CPU returns to sleep state again if no other task needs to be dealt with.

Thus, the CPU 14 is not needed every time a user refreshes the E-paper display 11, which saves a lot of energy.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic book reader comprising:
an E-paper display;
a display controller connected to the E-paper display;
a SDRAM connected to the display controller, and storing display data of a group of sequential pages; and
a plurality of control buttons electrically connected to the display controller for responding to user input and generating an updating signal to the display controller to open a destination page;
wherein the display controller is configured for accessing the SDRAM to obtain the display data of the destination page upon receiving the updating signal, and driving the E-paper display to display the destination page.

2. The electronic book reader as claimed in claim 1, further comprising a CPU connected to the display controller, and a storage unit connected to the CPU which stores display data of many groups of pages, the display controller is further configured for signaling the CPU to copy display data of a group of pages containing the destination page from the storage unit into the SDRAM via the display controller when the display data of the destination page is not in the SDRAM.

3. The electronic book reader as claimed in claim 1, wherein the E-paper display is for presenting graphic content.

4. The electronic book reader as claimed in claim 1, wherein the E-paper display is for presenting textual content.

5. The electronic book reader as claimed in claim 2, wherein after completing the task the CPU returns to sleep state if no other task needs to be dealt with.

6. The electronic book reader as claimed in claim 2, wherein the display controller is further configured for outputting a staring signal to the CPU to wake up the CPU first if the CPU is asleep.

7. An electronic book reader comprising:
an E-paper display;
a display controller connected to the E-paper display;
a SDRAM connected to the display controller and configured for storing display data of a group of pages;
at least one control button electrically connected to the display controller for responding to user input and generating an updating signal to the display controller to open a destination page;
a CPU connected to the display controller; and
a storage unit connected to the CPU, and storing a plurality of groups of display data;
wherein the display controller is configured for accessing the SDRAM to obtain the display data of the destination page upon receiving the updating signal, and driving the E-paper display to display the destination page; the display controller is configured for signaling the CPU to copy display data of a group of pages containing the destination page from the storage unit into the SDRAM via the display controller when the display data of the destination page is not in the SDRAM.

8. The electronic book reader as claimed in claim 7, wherein the E-paper display is for presenting graphic content.

9. The electronic book reader as claimed in claim 7, wherein the E-paper display is for presenting textual content.

10. The electronic book reader as claimed in claim 7, wherein after completing the task the CPU returns to sleep state again if no other task needs to be dealt with.

11. The electronic book reader as claimed in claim 7, wherein the display controller is further configured for outputting a staring signal to the CPU to wake up the CPU first if the CPU is asleep.
